(19) United States
(12) Patent Application Publication
(10) Pub. No.: US 2022/0184838 A1
(43) Pub. Date: Jun. 16, 2022

(54) SLICING MACHINE

(71) Applicant: MULTIVAC SEPP HAGGENMUELLER SE & CO. KG, Wolfertschwenden (DE)

(72) Inventor: Jochen ERTL, Neustadt (DE)

(73) Assignee: MULTIVAC SEPP HAGGENMUELLER SE & CO. KG, Wolfertschwenden (DE)

(21) Appl. No.: 17/547,924

(22) Filed: Dec. 10, 2021

(30) Foreign Application Priority Data
Dec. 11, 2020 (DE) 102020133162.2

(51) Int. Cl. B26D 7/06; B26D 7/22; B65G 23/14; B65G 23/30

(52) U.S. Cl. CPC B26D 7/0625; B65G 23/30; B65G 23/14; B26D 7/225

(57) ABSTRACT

In order to be able to reduce the number of required drive units in a multi-track slicing machine, in particular a multi-track slicer, for slicing a plurality of calibers simultaneously into slices, according to the invention second driven product guides for the, in particular all, tracks can only be driven together and have a freewheel unit acting in the feeding direction of the calibers.

### CROSS-REFERENCE TO RELATED APPLICATIONS

This application claims priority to German Patent Application No. DE 10 2020 133 162.2 filed on Dec. 11, 2020, the disclosure of which is incorporated in its entirety by reference herein.

### TECHNICAL FIELD

The invention relates to multi-track slicing machines, in particular so-called slicers, which are used in the food industry to slice strands of an only slightly compressible products such as sausage or cheese.

The invention further relates to a method for slicing a plurality of these strands simultaneously into slices by means of such a multi-track slicing machine.

### BACKGROUND

Since these strands can be produced with a cross section that maintains its shape and dimensions well over its length, i.e. essentially constant, they are called calibers or product calibers.

In most cases, several product calibers are cut open side by side at the same time by cutting one slice at a time from the same blade, which moves in a transverse direction to the longitudinal direction of the product calibers.

The product calibers are pushed forward by a feed conveyor in the direction of the blade, usually on an obliquely downwardly directed feed conveyor, and guided in each case through the product openings of a so-called cutting frame, at the front end of which the part of the product caliber protruding beyond it is cut off as a slice by the blade immediately in front of the cutting frame.

The slices generally fall onto a discharge conveyor, by means of which they are transported away for further processing.

In the case of multi-track slicing machines, it is possible not only to slice a plurality of calibers of the same type next to each other at the same time, but also to slice product pieces of different density and shape, whereby calibers of different products, such as cheese, salami, fresh sausage or the like, are located on the tracks of the slicing machine and are to be sliced next to each other as a shingled row.

However, the problem arises here that, as a rule, a slice thickness adapted to the corresponding product must be achieved for each of these different calibers, which is achieved by adjusting the feed speed of the calibers in the feeding direction.

In principle, this can be achieved by providing a separate drive unit at each track, both for the first, in particular upper, driven product guide and for the second, in particular lower, driven product guide arranged opposite, and thus varying the feed speed of all driven product guides.

However, this requires a high number of such drive units in such a multi-track slicing machine, which can have a detrimental effect not only on the manufacturing costs of the slicing machine, but also on the maintenance costs incurred during operation for the maintenance of the slicing machine.

### SUMMARY

It is therefore the object of the invention to provide a multi-track slicing machine, in particular a multi-track slicer, of the type described above, in which the slice thickness of calibers to be sliced simultaneously next to one another can be varied over the tracks without requiring a separate drive unit for each driven product guide.

With regard to the slicing machine, the object is solved in that, in the case of the multi-track slicing machine, in particular the multi-track slicer,
the second driven product guides for the, in particular all, tracks can only be driven together, and
the second driven product guides have a freewheel unit acting in the feeding direction of the calibers.

As a sequence of that, it is possible to set a separate feed speed for each track by means of the first driven product guides and thus to vary the slice thickness of calibers to be sliced simultaneously next to each other over the tracks, while the number of drive units to be provided for the second driven product guides can be reduced to a single drive unit for all tracks together.

Due to the fact that the freewheel unit of the second driven product guides acts in the feeding direction of the calibers, the second driven product guides can be operated at different feed speeds without the feed speed at which the second driven product guide of a track moves necessarily having to correspond to the feed speed of the drive unit assigned to this second driven product guide.

In principle, a plurality of drive units can also be provided for the second driven product guides, whereby it is possible, for example, to provide a separate drive unit for the second driven product guides assigned to each of a predetermined number of adjacent tracks.

According to an exemplary embodiment of the invention, with which the number of drive units to be provided can be reduced to a minimum, but the variability of the slice thickness mentioned at the beginning can be achieved without restriction, it is proposed, however, that the, preferably all, first driven product guides can each be driven by a separate drive unit, while the, preferably all, second driven product guides can be driven by a common drive unit.

In order to ensure that the feed speed of a caliber assigned to a track corresponds to the feed speed of the first driven product guide assigned to this track, it can further be provided that the freewheel unit of the second driven product guides can act in such a way that a movement of the second driven product guide of a track along the feeding direction substantially corresponds to a movement of the first driven product guide of the same track.

However, in order to be able to retract the calibers of all tracks sufficiently quickly in the event of an empty cut, i.e., for example, after completion of a mixed portion mentioned at the beginning, it is proposed according to a further embodiment that the freewheel unit only acts in the feeding direction of the calibers. This allows the calibers, preferably all of them, to be retracted quickly by essentially the same amount without any important slippage caused by the freewheel unit.

Furthermore, it is advantageous if the, preferably all, first driven product guides are arranged in a height-direction of the calibers below the calibers and the, preferably all, second driven product guides are arranged in the height-direction of the calibers above the calibers. Alternatively, however, it is also possible in principle that the, preferably all, first driven product guides are arranged in a height-direction of the calibers above the calibers and/or the, preferably all, second driven product guides are arranged in the height-direction of the calibers below the calibers.

In order to be able to ensure the traction required for precise guidance of the calibers between the calibers on the one hand and the driven product guides on the other hand, it can be provided that the, preferably all, first driven product guides and/or the, preferably all, second driven product guides are designed as driven belt conveyors with a guide belt.

If at least the second driven product guides are designed as driven belt conveyors with a guide belt, the freewheel unit of the second driven product guides can be designed between a belt drive unit and a deflection roller of the guide belt of the belt conveyor. As a sequence thereof, at best, only a corresponding freewheel unit needs to be provided at a connection point of each of the second driven product guides to the drive unit or drive units of the second driven product guides, and otherwise substantially unchanged components can be used.

In order to enable the freewheel unit to act in the feeding direction of the calibers, but not when retracted in the caliber, i.e. the feeding direction, the freewheel unit of the second driven product guides may preferably comprise one or more locking elements which are adjustable between a locking position, in which relative movement between the belt drive unit and the deflection roller of the guide belt is substantially prevented, and a release position, in which relative movement between the belt drive unit and the deflection roller of the guide belt is permitted.

If the freewheel unit comprises the aforementioned locking elements, these can in principle be selectively transferred to their locking position or release position by means of a suitable actuator. Preferably, however, the locking elements are biased into their locked position, in particular by means of a spring.

If the locking elements are pretensioned into their locking position, it can also be provided that the locking elements are designed in such a way that they are transferred from their locking position to the release position essentially automatically during a movement of the belt drive unit relative to the guide belt and thus the deflection roller corresponding to the direction of action of the freewheel unit, i.e., the feeding direction. For this purpose, a corresponding active surface, in particular an inclined contact surface, can be provided on the deflection roller and/or the belt drive unit, which interacts accordingly with the respective locking element, whereby the pretensioning force acting in the locking position may have to be overcome. If the above-mentioned springs are also provided, the frictional force between the effective surface and the locking element can be adapted by adjusting the spring constant.

In order to be able to change the direction of a product guide lying against the caliber, in particular of the guide belt of the belt conveyor lying against the caliber, according to one exemplary embodiment the, preferably all, first driven product guides and/or the, preferably all, second driven product guides are embodied to be pivotable about one of their deflection rollers.

In order to be able to move the calibers during slitting, for example to one of their end facing away from a cutting frame of the slicing machine, it is possible to hold the end facing away from a cutting frame of the slicing machine, the feed unit can further comprise a gripper unit comprising a gripper slide and grippers attached thereto for each track, and the and the gripper unit comprises a slide drive for driving the gripper slide along a gripper slide along a slide guide.

With regard to the method, the object mentioned at the beginning is solved in that
the first driven product guides of the, preferably all, tracks are each driven separately in a controlled manner in the feeding direction, and
one, in particular single, drive unit provided for the second driven product guides of the, preferably all, tracks is operated at a speed in the feeding direction which corresponds to the feed speed of the track moving fastest in the feeding direction.

Already at this point it should be pointed out that all advantages and effects which have been described with respect to the slicing machine according to the invention also apply to the process according to the invention.

According to the invention, therefore, only the first driven product guides need to be driven in a track-selective manner, i.e., separately for each track, while the second driven product guides are controlled via the, preferably single, drive unit provided for the second driven product guides.

This results in a significantly reduced control effort, since it is not necessary to synchronously operate the drive units of the oppositely arranged first and second driven product guides for each track in order to slice mixed portions of different slice thicknesses, as in the prior art. At the same time, however, a track-selective feed speed of the calibers in the feeding direction can be achieved, which is achieved by track-selective control of the first driven product guides in the feeding direction.

Furthermore, at least before an empty cut, i.e., after completion of a mixed portion mentioned at the beginning, the second product guides of the, preferably all, tracks can each be moved against the feeding direction at essentially the same retraction speed in order to quickly retract the calibers by essentially the same amount without any important slip caused by the freewheel unit occurring.

It should be added that the speed of the drive unit for the second driven product guides can correspond to the feed speed of the track on which the slices are cut with a maximum slice thickness.

### BRIEF DESCRIPTION OF THE DRAWINGS

Embodiments according to the invention are described in more detail below by way of example. They show:

FIGS. 1a, b: a slicing machine in the form of a slicer according to the prior art in different perspective views,

FIG. 1c: the slicing machine of FIGS. 1a, b in side view,

FIG. 2a: a simplified vertical longitudinal section through the slicing machine of FIGS. 1a-c, i.e. in the same direction of view as FIG. 1c, in which the various conveyor belts can be seen more clearly, with the feed belt tilted up into the slicing position,

FIG. 2b: a longitudinal section as in FIG. 2a, but with the infeed belt tilted down into the loading position and the product caliber in an advanced state of cutting,

FIG. 3a: an enlarged detail view of a section of FIG. 2b,

FIG. 3b1: a detailed view of a driven lower product guide designed as a belt conveyor with a freewheel unit, which is provided for a slicing machine according to the invention, and

FIG. 3b2: a detailed view of a driven upper product guide embodied as a belt conveyor with a freewheel unit, which is provided for the slicing machine according to the invention.

### DETAILED DESCRIPTION

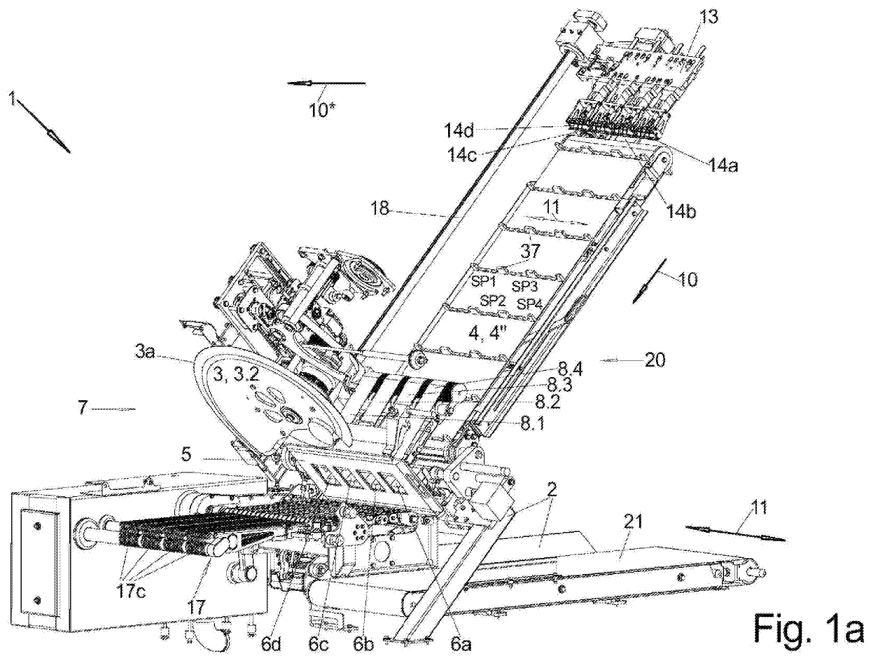

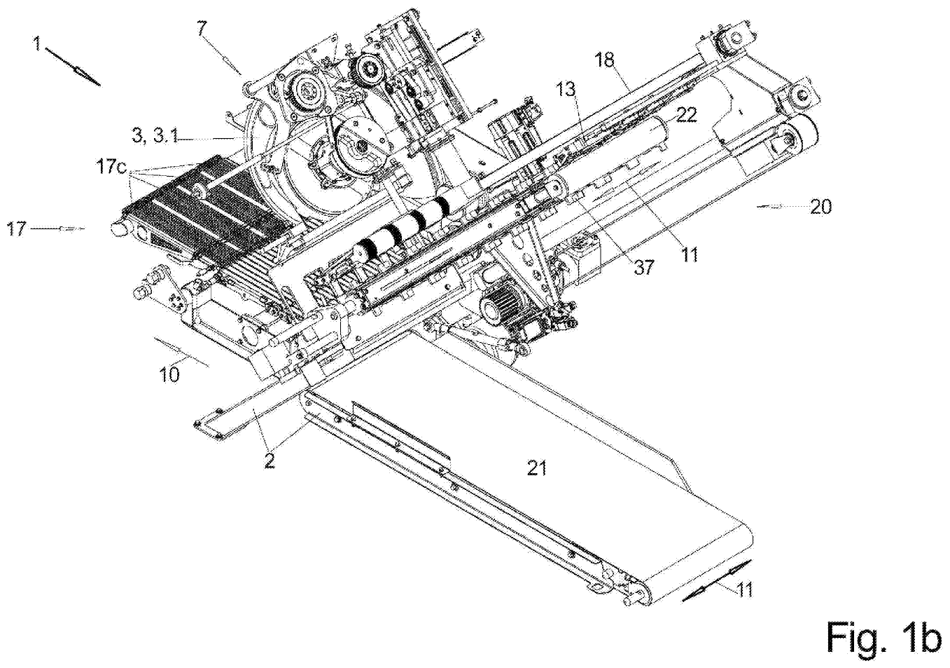

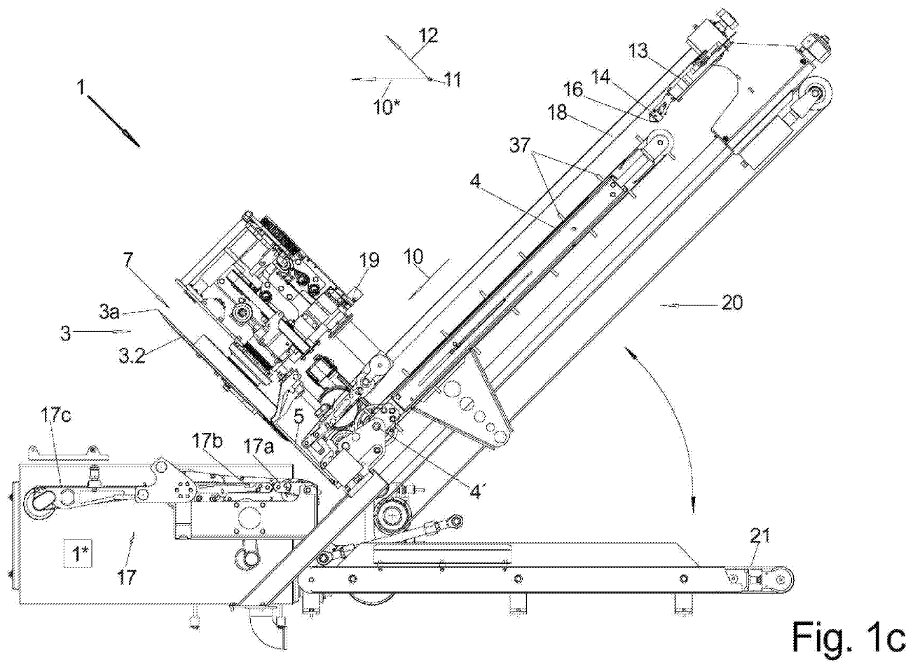

FIGS. 1a, 1b show different perspective views of a slicer 1 for simultaneous slicing of a plurality of product calibers K side by side on different tracks SP1 to SP4 and depositing in shingled portions P of several slices S each with a general passage direction 10* through the slicer 1 from left to right as well as FIG. 1c a side view of this slicer 1.

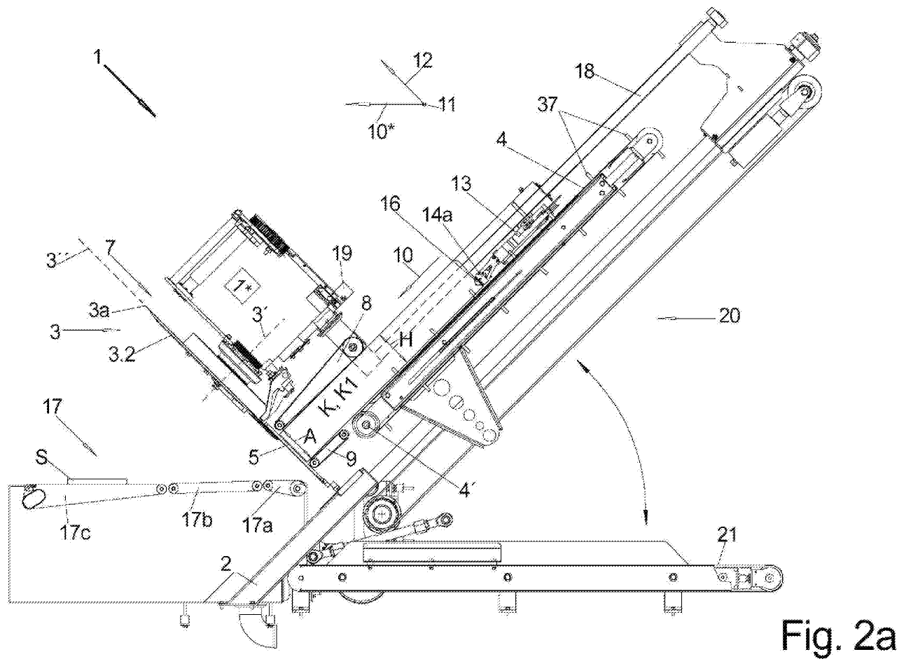

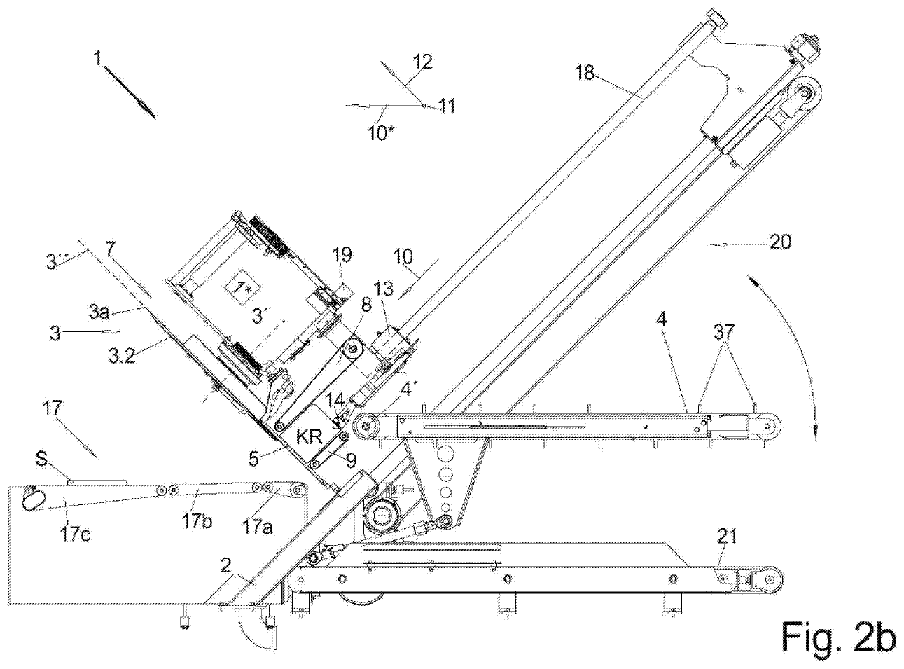

FIG. 2a shows a vertical section through such a slicer 1 in longitudinal direction 10, the feeding direction of the calibers K to the cutting unit 7 and thus the longitudinal direction of the calibers K lying in the slicer 1, i.e., with the same viewing direction as FIG. 1c, simplified by omitting details less important for the invention.

It can be seen that the basic structure of a slicer 1 according to the state of the art is that a cutting unit 7 with a rotating sickle blade 3 is fed with a plurality of, in this case four, product calibers K lying next to each other transversely to the feeding direction 10 by a feed unit 20, from the front ends of each of which the rotating sickle blade 3 simultaneously separates a slice S.

For this purpose, the feed unit 20 comprises a feed conveyor 4 in the form of an endless, circulating feed belt 4, the upper run of which can be driven at least in the feeding direction 10 and also in opposition thereto, the calibers K lying next to one another in the width of this feed conveyor being arranged on the feed belt 4 at a distance from one another in the feeding direction 10 mostly by means of spacers 15 which project outwards from the feed belt 4 with respect to the direction of circulation, i.e., upwards from the upper run.

For slicing the product calibers K, the feed conveyor 4 is in the inclined position shown in FIGS. 1a-c and 2a with a low-lying cutting-side front end and a high-lying rear end, from which it can be tilted down into an approximately horizontal loading position about a pivot axis 20′ running in its width direction, the 1st transverse direction 11, which is located in the vicinity of the cutting unit 7.

The rear end of a caliber K—lying in the feed unit 20 is held positively in each case by a gripper 14a-d with the aid of gripper claws 16. These grippers 14a-14d, which can be activated and deactivated with respect to the position of the gripper claws 16, are attached to a common gripper unit 13, which can be fed along a rod-shaped gripper guide 18 in the feeding direction 10.

Both the feed of the gripper unit 13 and the feed conveyor 4 can be driven in a controlled manner, but the specific feed speed of the calibers K is effected by a so-called upper and lower product guide 8, 9, which engage the upper and lower sides of the calibers K to be cut at their front end regions near the cutting unit 7:

The front ends of the calibers K are each guided through a so-called product opening 6a-d present for each caliber, which are formed in a plate-shaped cutting frame 5, which is a component of the cutting unit 7, in that the cutting plane 3″, in which the sickle blade 3 rotates with its cutting edge 3a and thus cuts off the projection of the calibers K from the cutting frame 5 as a slice S, runs directly in front of the front end face of the cutting frame 5, which points obliquely downwards. The cutting plane 3″ runs perpendicular to the upper run of the feed conveyor 4 and/or is spanned by the two transverse directions 11, 12.

The inner circumference of the product openings 6a-d of the cutting edge 3a of the blade 3 serves as a counter cutting edge.

Although the product openings 6a-d of the replaceable cutting frame 5 are approximately adapted to the cross section shape and size of the calibers K to be cut on the various tracks SP1 to SP4, since their cross section size is subject to production-related fluctuations, the cross section of the product openings 6a-d is generally somewhat larger than the cross section of the caliber K to be cut.

In order to nevertheless achieve a good cutting result and to be able to control parameters such as the contact force of the caliber K on the inner circumferential surface of the spectacle opening 6a-d and other parameters, the bottom and top product guides 8, 9, each in the form of a conveyor belt, are provided, of which the bottom product guide 9 with its upper run and the top product guide 8 with the lower run of the corresponding conveyor belt are in frictional contact with the underside and top side of the caliber K respectively.

Since both product guides 8, 9 can be driven in a controlled manner, they determine the—continuous or clocked—feed speed of the calibers K through the cutting frame 5. Preferably, the two product guides 8, 9 are present and controllable separately for each caliber K in the 1. transverse direction 11.

In addition, at least the upper product guide 8 is displaceable in the 2. transverse direction 12—which is perpendicular to the surface of the upper run of the feed conveyor 4 tilted up into the cutting position—for adaptation to the height H of the caliber K in this direction. Furthermore, at least one of the product guides 8, 9 can be embodied to be pivotable about one of its deflection rollers 8a, 8b, 9a, 9b in order to be able to change the direction of the run of its conveyor belt resting against the caliber K to a limited extent.

The slices S, which stand at an angle in the space corresponding to the inclined position of the feed unit 20 and cutting unit 7 during separation, fall onto a discharge unit 17 which starts below the cutting frame 5 and runs in the passage direction 10* and which in this case consists of a plurality of discharge conveyors 17a, b, c arranged one behind the other with their upper runs approximately aligned in the passage direction 10*, one of which can also be embodied as a weighing unit.

The slices S fall either directly onto these discharge conveyors 17a-c, as shown in FIGS. 1c and 2a, or onto a packaging element resting thereon, such as a carrier carton or a flat plastic tray.

Below the feed conveyor unit 20, there is also an approximately horizontally running endpiece conveyor 21, likewise in the form of an endlessly circulating conveyor belt, which starts with its front end below the cutting frame 5 and directly below or behind the discharge unit 17 and with its upper run transports endpieces falling thereon away to the rear against the passage direction 10*.

For this purpose, at least the first discharge conveyor 17a in the passage direction 10* can be driven with its upper run counter to the passage direction 10* so that an end piece falling thereon, for example, can be transported to the rear and fall onto the lower-lying end piece conveyor 21.

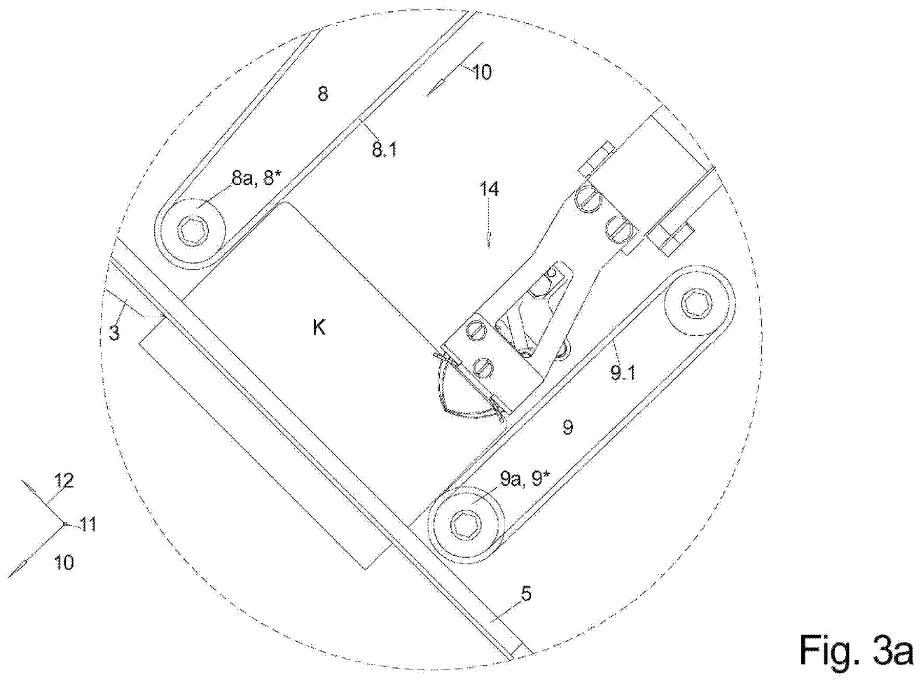

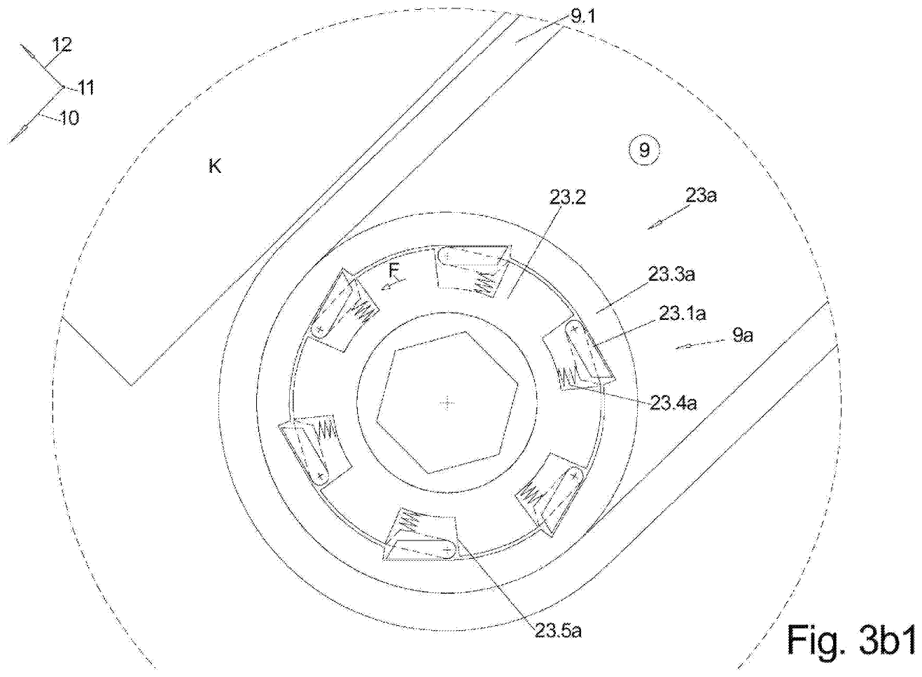

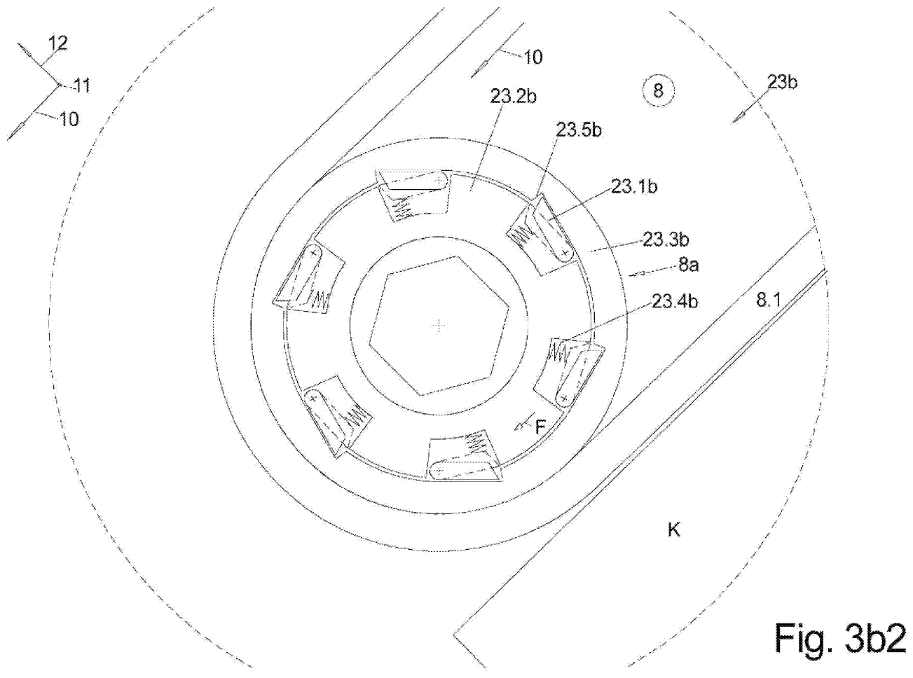

FIG. 3a shows an enlarged detailed view of a section of FIG. 2b, in which the driven product guides 8, 9 embodied as belt conveyors and the gripper 14 holding the caliber K can be seen in the area of the cutting frame 5 of the slicer 1. The upper product guide 8 can be driven by a drive unit 8* acting in the region of the deflection roller 8a, while the lower product guide 9 can be driven by a drive unit 9* acting in the region of the deflection roller 9a.

Since, as already explained with FIGS. 1a-c, the slicer 1 is a multi-track slicer 1, the slicer 1 comprises for each track an upper product guide 8 and a bottom product guide 9 arranged opposite thereto, i.e. in the first transverse direction 11 both a plurality of upper product guides 8 and a plurality of lower product guides 9.

If the slicer 1 is used to cut so-called mixed portions, the blades of the slicer 1 contain calibers K of different products, such as cheese, salami, fresh sausage or the like, which are to be sliced next to each other as a shingled row. In order to achieve a slice thickness adapted to the corresponding product for each of these different calibers K, a correspondingly adapted feed speed must be achieved for each caliber K in the feeding direction 10 to the cutting frame 10.

The special feature according to the invention now consists in the fact that in the slicer 1 according to the invention either only the upper product guides 8 or only the lower product guides 9 can be driven separately for each track SP1 to SP4. The other product guides 8 or 9 can only be driven together for each track SP1 to SP4, i.e., at the same speed in the feeding direction 10.

In order to be able to achieve different feed speeds of the calibers K in the feeding direction 10 for each track SP1 to SP4, a freewheel unit acting in the feeding direction 10 of the calibers K is provided according to the invention in those of the product guides 8 or 9 which can only be driven together for each track, which will be described in more detail with reference to FIGS. 3b1 and 3c2.

FIG. 3b1 shows an exemplary embodiment of a freewheel unit 23a acting in the feeding direction 10, which is formed on the lower product guide 9. The freewheel unit 23a comprises locking elements 23.1a, which are operatively connected to a belt drive unit 23.2a of the lower product guide 9.

In the exemplary embodiment shown, the locking elements 23.1a are pivotably mounted on the belt drive unit 23.2a and are thereby adjustable between a locking position, in which the locking elements 23.1a engage with a connecting part 23.3a, which is non-rotatably connected to the deflection roller 9a, in such a way that a relative movement between the connecting part 23.3a, which corresponds to an advance of the belt drive unit 23.2a in the direction of arrow F relative to the connecting part 23.3a, is substantially prevented, and a release position (shown in dashed lines), in which this relative movement between the belt drive unit 23.2a and the connecting part 23.3a, which is connected to the deflection roller 9a in a rotationally fixed manner, is permitted.

In other words, due to the action of the freewheel unit 23a, it is possible for the upper run 9.1 to move in the feeding direction 10 at a feed speed which is slower than the feed speed of the upper run 9.1 in the feeding direction 10 caused by the rotation of the belt drive unit 23.2a.

Each of the locking elements 23.1a is thereby biased into the locking position by means of a spring 23.4a.

However, in order to be able to retract the calibers K of all tracks SP1 to SP4 sufficiently quickly in the case of an empty cut, i.e., for example, after completion of a mixed portion mentioned at the beginning, the freewheel 23a acts only in the feeding direction 10a of the calibers K, so that all calibers K can be retracted quickly by essentially the same amount against the feeding direction 10, without any important slip caused by the freewheel 23a between the belt drive unit 23.2a and the connecting part 23.3a or the deflection roller 9a caused by the freewheel 23a.

This is achieved by preventing movement of the belt drive unit 23.2a in the direction opposite to the direction of arrow F relative to the connecting part 23.3a by the locking elements 23.1a. These namely then remain in their locking position and engage in latching recesses 23.5a, which prevent the relative movement between the drive unit 23.2a and the connecting element 23.3a, which is non-rotatably connected to the deflection roller 9a, in the opposite direction.

In contrast, FIG. 3b2 shows an exemplary embodiment of a freewheel unit 23b acting in the feeding direction 10, which is formed on the upper product guide 8.

The same parts of the freewheel unit 23b are provided with analogous reference signs as in FIG. 3b1, but supplemented by the additional letter “b” instead of “a”. The function and effect of the freewheel unit 23b as shown in FIG. 3b2 corresponds essentially to the freewheel unit 23a in FIG. 3b1, the description of which is hereby expressly referred to.

### REFERENCE LIST

1 slicing machine, slicer
1* control
2 base frame
3 blade, sickle blade
3 rotation axis
3″ blade plane, cutting plane
3a cutting edge
4 feed conveyor, feed belt
5 cutting frame
6a-d product opening
7 cutting unit
8 upper product guide, upper guide belt
8.1 contact run, lower run
8a cutting side deflection roller
8b deflection roller facing away from the cutting side
9 bottom product guide, lower guide belt
9.1 contact run, upper run
9a cutting side deflection roller
9b deflection roller facing away from the cutting side
10 feed direction, longitudinal direction, axial direction,
10* pass through direction
11 1. transverse direction (width slicer)
12 2. transverse direction (height-direction caliber)
13 gripper unit, gripper slide
14, 14a-d gripper
15 spacer
15′ support surface
16 gripper claw
17 discharge conveyor unit
17a, b, c portioning belt, discharge conveyor
18 gripper guide
19 height sensor
20 feed unit
21 end piece conveyor
22 end piece container
23a, b freewheel unit
23.1a, 23.1b locking element
23.2a, 23.2b drive unit, belt drive unit
23.3a, 23.3b connecting part
23.4a, 23.4b spring
23.5a, 23.5b latching recesses
K product, product caliber
Kr end piece
S slice
P portion
V packaging element

1. A multi-track slicing machine, in particular multi-track slicer, for slicing a plurality of calibers simultaneously into slices, comprising:
a cutting unit,
a multi-track feed unit for feeding a plurality of calibers side by side along a feeding direction to the cutting unit
a first driven product guide per track at the front end of each track,
the first driven product guide per track being separately and independently drivable for each track,
a second driven product guide per track at the front end of each track, which is arranged opposite to the driven first product guide per track in relation to the calibers
a control for controlling moving parts of the slicing machine,
wherein
the second driven product guide for the, in particular all, tracks can only be driven together, and
the second driven product guide has a freewheel unit acting in the feeding direction of the calibers.

2. The slicing machine according to claim 1,
wherein
the, preferably all, first driven product guides are each drivable by a separate drive unit, while the, preferably all, second driven product guides are drivable by a common drive unit.

3. The slicing machine according to claim 1,
wherein
the freewheel unit of the second driven product guides can act in such a way that a movement of the second driven product guide of a track along the feeding direction substantially corresponds to a movement of the first driven product guide of the same track.

4. The slicing machine according to claim 1,
wherein
the freewheel unit acts only in the feeding direction of the calibers.

5. The slicing machine according to claim 1,
wherein
the, preferably all, first driven product guides are arranged in a height-direction of the calibers below the calibers, and the, preferably all, second driven product guides are arranged in the height-direction of the calibers above the calibers
and/or
the, preferably all, first driven product guides are arranged in the height-direction of the calibers above the calibers, and the, preferably all, second driven product guides are arranged in the height-direction of the calibers below the calibers.

6. The slicing machine according to claim 1,
wherein
the, preferably all, first driven product guides and/or the, preferably all, second driven product guides are embodied as driven belt conveyors with a guide belt.

7. The slicing machine according to claim 6,
wherein
the freewheel unit of the second driven product guides is positioned between a belt drive unit and a deflection roller of the guide belt (8.1, 9.1) of the belt conveyor.

8. The slicing machine according to claim 7,
wherein
the freewheel unit of the second driven product guides comprises one or more locking elements which are adjustable between a locking position in which a relative movement between the belt drive unit and the deflection roller of the guide belt is substantially prevented, and a release position in which the relative movement between the belt drive unit and the deflection roller of the guide belt is permitted.

9. The slicing machine according to claim 8,
wherein
the locking elements are biased into their locking position, preferably by means of a spring.

10. The slicing machine according to claim 1,
wherein
the, preferably all, first driven product guides and/or the, preferably all, second driven product guides are designed to be pivotable, preferably about one of their deflection rollers.

11. The slicing machine according to claim 1,
wherein
the feed unit comprises a gripper unit with a gripper slide and grippers attached thereto for each track,
the gripper unit has a slide drive for driving the gripper slide along a slide guide.

12. A method for slicing a plurality of calibers simultaneously in slices by means of a multi-track slicing machine, in particular a multi-track slicer, with
a first driven product guide per track, and
a second driven product guide per track opposite to the first driven product guide per track with respect to the calibers,
wherein
at least in slicing operation, the first and second product guides of at least two tracks are each driven at a different feed speed from one another in the feeding direction,
wherein
the first driven product guides of the, preferably all, tracks are each driven separately in the feeding direction in a controlled manner, and
a drive unit, in particular a single one, provided for the second driven product guides of the, preferably all, tracks is operated in the feeding direction at a speed which corresponds to the feed speed of the track moving fastest in the feeding direction.

13. The method according to claim 12,
wherein
at least before an empty cut, the second product guides, and in particular also the first product guides, of the, preferably all, tracks are each moved counter to the feeding direction at substantially the same retraction speed.

14. The method according to claim 12,
wherein
the speed of the drive unit for the second driven product guides corresponds to the feed speed of the track on which the slices are cut with a maximum slice thickness.
